(19) United States
(12) Patent Application Publication
(10) Pub. No.: US 2024/0008159 A1
(43) Pub. Date: Jan. 4, 2024

(54) SWITCH GANG-CONTROL DEVICE BASED ON LED TREE LIGHTS

(71) Applicant: Chen XueLI, Taizhou (CN)

(72) Inventor: Chen XueLI, Taizhou (CN)

(21) Appl. No.: 17/857,078

(22) Filed: Jul. 4, 2022

(51) Int. Cl. H05B 47/19

(52) U.S. Cl. CPC H05B 47/19

(57) ABSTRACT

The utility model belongs to the technical field of control of LED tree lights, and relates to a switch gang-control device based on LED tree lights. The device includes an LED tree body, in which a control mechanism for turning on or off the lights is disposed, and the on or off of the LED tree lights within a defined range is controlled in real time by means of the control mechanism and according to a wireless encoded signal. The gang control of a plurality of LED tree lights can be implemented; and the sending and receiving of wireless data is more user-friendly and intelligent by means of two-way wireless communication. A point-contact power supply solution is used to avoid a wire winding problem during assembly. A contact pin has an elastic design, such that effective contact can be ensured when the contact pin leans against a contact piece, making the mode of power supply more stable and reliable. Meanwhile, the elastic design can also prevent a component from being damaged due to the deformation of a contact point during the leaning; the contact piece has an annular design, which effectively ensures the contact between the contact piece and a landing point of the contact pin; furthermore, both ends of the contact piece are each provided with an insert tab to facilitate the insertion into a base, making the assembly simpler and more convenient.

### BACKGROUND OF THE INVENTION

### 1. Technical Field

The utility model belongs to the technical field of control of LED tree lights, and in particular, relates to a switch gang-control device based on LED tree lights.

### 2. Description of Related Art

At present, LED trees in the market are controlled by a single switch, which is not available for the gang control of a plurality of LED trees, each LED tree can be independently turned on or off only by a switch, and for most products, string lights are powered by means of direct connection between a wire and a battery box.

Therefore, in view of the technical problems and defects that the LED trees in the market are basically controlled by a single switch, which is not available for the gang control of a plurality of LED trees, each LED tree can be independently turned on or off only by a switch, and for most products, string lights are powered by means of direct connection between a wire and a battery box, there is an urgent need of designing and developing a switch gang-control device based on LED tree lights.

### BRIEF SUMMARY OF THE INVENTION

To overcome the above-mentioned defects and difficulties in the prior art, an object of the utility model is to provide a switch gang-control device based on LED tree lights to implement the gang control of a plurality of LED tree lights.

The object of the utility model is to provide a switch gang-control device based on LED tree lights.

The object of the utility model is achieved as follows: the device includes an LED tree body, in which a control mechanism for turning on or off the lights is disposed, and the turning on or off of the LED tree lights within a defined range is controlled in real time according to a wireless encoded signal by means of the control mechanism.

Further, a control circuit for turning on or off the LED tree lights is disposed in the control mechanism.

Further, a first processing chip is disposed in the control circuit;
a first pin of the first processing chip is connected to a power end and one end of a third capacitor; the other end of the third capacitor and an eighth pin of the first processing chip are grounded jointly;
a second pin of the first processing chip is electrically connected to a wireless signal receiver; a third pin of the first processing chip is connected to one end of a first switch, and the other end of the first switch is grounded;
a fifth pin of the first processing chip is electrically connected to a wireless signal emitter; and a seventh pin of the first processing chip is connected to one end of a first resistor, the other end of the first resistor is connected to a base electrode of a first triode, an emitter electrode of the first triode is grounded, a collector electrode of the first triode is connected to one end of a second resistor, the other end of the second resistor is connected to a negative electrode of a first LED light, and a positive electrode of the first LED light is connected to a power input end.

Further, a first processing chip is disposed in the control circuit; and a first processing chip is disposed in the control circuit;
a first pin of the first processing chip is connected to a power end and one end of a third capacitor; the other end of the third capacitor and an eighth pin of the first processing chip are grounded jointly;
a second pin of the first processing chip is electrically connected to a wireless signal receiver; a third pin of the first processing chip is connected to one end of a first switch, and the other end of the first switch is grounded;
a fifth pin of the first processing chip is electrically connected to a wireless signal emitter; and a seventh pin of the first processing chip is connected to one end of a first resistor, the other end of the first resistor is connected to a base electrode of a first triode, an emitter electrode of the first triode is grounded, a collector electrode of the first triode is connected to one end of a second resistor, the other end of the second resistor is connected to a negative electrode of a first LED light, and a positive electrode of the first LED light is connected to a power input end; and
a sixth pin of the first processing chip is connected to one end of a third resistor, the other end of the third resistor is connected to a negative electrode of a second LED light, and a positive electrode of the second LED light is connected to the power input end.

Further, the first processing chip is configured to encode data and send the encoded data to an LED tree within the defined range by means of a wireless signal sending circuit; and
to process a wireless signal received by a wireless signal receiving circuit and control the on or off of the LED tree lights according to data obtained by processing.

Further, the first processing chip is specifically U280.

Further, the LED tree body is specifically powered in a point contact mode.

Further, a contact pin disposed in the point contact mode is specifically an elastic contact pin; and a contact piece disposed in the point contact mode is specifically an annular contact piece.

Further, both ends of the contact piece are each provided with an insert tab for insertion into a base.

Further, an indicator light for determining a product working status is disposed on the LED tree body.

Further, a controller button cap is disposed in the control mechanism; and the button cap is injection-molded on a housing of the base of the LED tree body.

The utility model further provides a method for applying a switch gang-control device based on LED tree lights. The method includes the following steps:
emitting, based on the on or off of a switch mechanism disposed in any one of LED tree bodies, a wireless encoded signal corresponding to the LED tree body by a wireless signal emitter;
receiving the wireless encoded signal in real time by means of a wireless signal receiver disposed in an LED tree within a defined range; and
controlling the on or off of the LED tree lights within the defined range in real time in combination with the switch mechanism of the LED tree body according to the received wireless encoded signal.

According to the utility model, a charge/discharge device body is controlled by the defined device. The defined device includes an LED tree body, in which a control mechanism for turning on or off lights is disposed, and the on or off of the LED tree lights within a defined range is controlled in real time according to a wireless encoded signal by means of the control mechanism. The gang control of a plurality of LED tree lights can be implemented; and the sending and receiving of wireless data is more user-friendly and intelligent by means of 433M (315M or 2.4G) two-way wireless communication. A point-contact power supply solution is used to avoid a wire winding problem during assembly. In addition, a contact pin has an elastic design, such that effective contact can be ensured when the contact pin leans against a contact piece, making the mode of power supply more stable and reliable. Meanwhile, the elastic design can also prevent a component from being damaged due to the deformation of a contact point during the leaning; the contact piece has an annular design, which can effectively ensure the contact between the contact piece and a landing point of the contact pin; furthermore, both ends of the contact piece are each provided with an insert tab to facilitate the insertion into the base, making the assembly simpler and more convenient.

### BRIEF DESCRIPTION OF THE SEVERAL VIEWS OF THE DRAWINGS

For clearer description of the technical solutions in the embodiments of the present utility model, the following briefly introduces the accompanying drawings required to be used in the description of the embodiments. Apparently, the accompanying drawings in the following description show merely some embodiments of the utility model, and a person of ordinary skills in the art may still derive other drawings from these accompanying drawings without creative efforts.

FIG. 1 is a schematic diagram showing a frame structure of a switch gang-control device based on LED tree lights according to the utility model;

FIG. 2 is a schematic diagram showing a control circuit of a switch gang-control device based on LED tree lights according to the utility model;

FIG. 3 is a schematic diagram showing another control circuit of a switch gang-control device based on LED tree lights according to the utility model;

FIG. 4 is a schematic front view showing an LED tree body of a switch gang-control device based on LED tree lights according to the utility model; and

FIG. 5 is a schematic stereoscopic view showing an LED tree body of a switch gang-control device based on LED tree lights according to the utility model.

In the drawings, reference signs are as follows:

1—LED tree body; U1—first processing chip; C3—third capacitor; Q1—first triode; R1—first resistor; R2—second resistor; R3—third resistor; S1—first switch; J1—wireless signal receiver; J2—wireless signal emitter, LED1—first LED light; and LED2—second LED light.

The object achievement, functional characteristics, and advantages of the utility model will be further illustrated in combination with embodiments and with reference to the accompanying drawings.

### DETAILED DESCRIPTION OF THE INVENTION

For a better and clearer understanding of the object, technical solution and advantages of the utility model, the utility model will be further illustrated below in combination with the accompanying drawings and particular embodiments, and a person skilled in the art would be able to readily learn other advantages and functions of the utility model from the content disclosed in the present specification.

The utility model may also be implemented or applied by means of other different examples. Without departing from the spirit of the utility model, various modifications and alternations can be made to the details in the present specification based on different opinions and applications.

It should be noted that in the case of a directional indication (such as, up, down, left, right, front, back, etc.) in the embodiments of the utility model, it only serves to explain a relative positional relationship, a motion condition and the like between various components under a specific posture (as shown in the accompanying drawings). If the specific posture changes, the directional indications change therewith accordingly.

In addition, the descriptions such as “first” and “second” involved in the embodiments of the utility model are merely for a descriptive purpose, and shall not be construed as indicating or implying their relative importance or implicitly indicating the number of technical features indicated. As such, features defined by “first” and “second” can explicitly or implicitly include at least one of said features. Then, the technical solutions of various embodiments can be mutually combined, which must be based on the fact that it is implementable for those skilled in the art. When the technical solutions are in conflict during the combining or the combination is not achievable, it should be considered that such a combination does not exist and is not within the protection scope claimed by the utility model.

The utility model will be further set forth below in conjunction with the accompanying drawings.

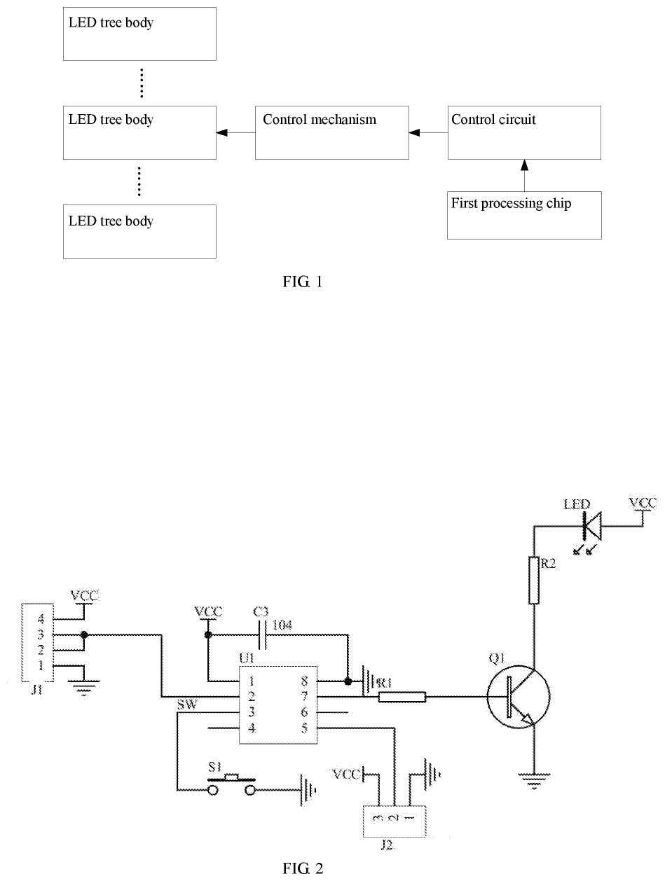

As shown in FIGS. 1-2, the utility model provides a switch gang-control device based on LED tree lights. The device includes an LED tree body 1, in which a control mechanism for turning on or off the light is disposed, and the on or off of the LED tree lights within a defined range is controlled in real time according to a wireless encoded signal by means of the control mechanism.

A control circuit for turning on or off the LED tree lights is disposed in the control mechanism. A first processing chip U1 is disposed in the control circuit.

A first pin of the first processing chip U1 is connected to a power end and one end of a third capacitor C3; and the other end of the third capacitor C3 and an eighth pin of the first processing chip U1 are grounded jointly.

A second pin of the first processing chip U1 is electrically connected to a wireless signal receiver; and a third pin of the first processing chip U1 is connected to one end of a first switch S1, and the other end of the first switch S1 is grounded.

A fifth pin of the first processing chip U1 is electrically connected to a wireless signal emitter. A seventh pin of the first processing chip U1 is connected to one end of a first resistor R1; the other end of the first resistor R1 is connected to a base electrode of a first triode Q1; an emitter electrode of the first triode Q1 is grounded; a collector electrode of the first triode Q1 is connected to one end of a second resistor R2; the other end of the second resistor R2 is connected to a negative electrode of a first LED light; and a positive electrode of the first LED light is connected to a power input end.

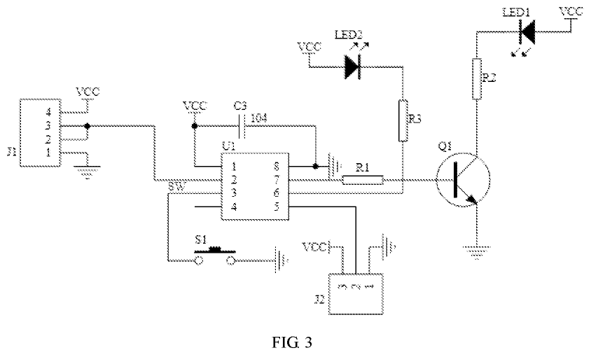

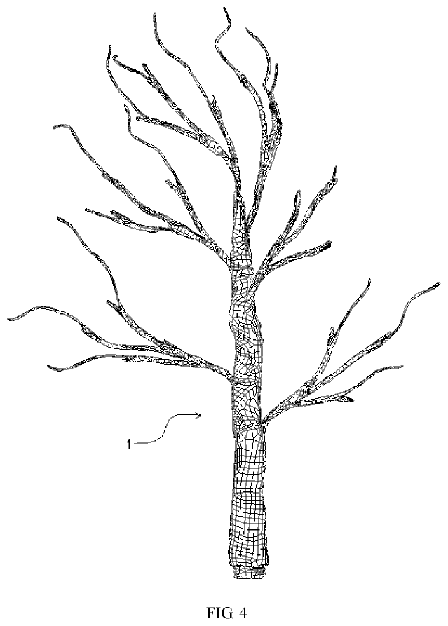

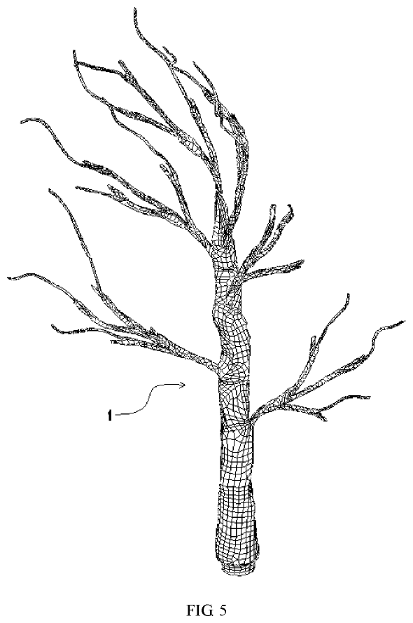

Preferably, in another particular embodiment further provided by the utility model, a control circuit for turning on or off the LED tree lights is disposed in the control mechanism. As shown in FIG. 3, a first processing chip U1 is disposed in the control circuit.

A first pin of the first processing chip U1 is connected to a power end and one end of a third capacitor C3; and the other end of the third capacitor C3 and an eighth pin of the first processing chip U1 are grounded jointly.

A second pin of the first processing chip U1 is electrically connected to a wireless signal receiver; and a third pin of the first processing chip U1 is connected to one end of a first switch S1, and the other end of the first switch S1 is grounded.

A fifth pin of the first processing chip U1 is electrically connected to a wireless signal emitter. A seventh pin of the first processing chip U1 is connected to one end of a first resistor R1; the other end of the first resistor R1 is connected to a base electrode of a first triode Q1; an emitter electrode of the first triode Q1 is grounded; a collector electrode of the first triode Q1 is connected to one end of a second resistor R2; the other end of the second resistor R2 is connected to a negative electrode of a first LED light; and a positive electrode of the first LED light is connected to a power input end.

A sixth pin of the first processing chip U1 is connected to one end of a third resistor R3, the other end of the third resistor R3 is connected to a negative electrode of a second LED light, and a positive electrode of the second LED light is connected to the power input end.

The first processing chip U1 is configured to encode data and send the encoded data to an LED tree within the defined range by a wireless signal sending circuit; and to process a wireless signal received by a wireless signal receiving circuit and control the on or off of the LED tree lights according to data obtained by processing.

The first processing chip U1 is specifically U280.

The LED tree body 1 is specifically powered in a point contact mode. A contact pin disposed in the point contact mode is specifically an elastic contact pin; and a contact piece disposed in the point contact mode is specifically an annular contact piece.

Both ends of the contact piece are each provided with an insert tab for insertion into a base. An indicator light for determining a product working status is disposed on the LED tree body 1.

A controller button cap is disposed in the control mechanism; and the button cap is injection-molded on a housing of the base of the LED tree body 1.

The utility model further provides a method for applying a switch gang-control device based on LED tree lights. The method includes the following steps:
emitting, based on the on or off of a switch mechanism disposed in any one of LED tree bodies 1, a wireless encoded signal corresponding to the LED tree body 1 by a wireless signal emitter;
receiving the wireless encoded signal in real time by means of a wireless signal receiver disposed in an LED tree within a defined range; and
controlling the on or off of the LED tree lights within the defined range in real time in combination with the switch mechanism of the LED tree body 1 according to the received wireless encoded signal.

Specifically, in a particular embodiment of the utility model, a switch gang-control device based on LED tree lights is provided. In terms of electronics, 433M (315M or 2.4G) two-way wireless communication is added, such that a plurality of LED trees can be turned on or off simultaneously or individually. When the lights on one of the trees are turned on or off via a button, the tree emits a corresponding wireless encoded signal; trees within a defined range receive wireless signals from other trees, then decode the wireless signals from the corresponding trees, and then take a corresponding action of turning on or off the lights based on data signals obtained by decoding, thereby demonstrating the functional setting of synchronously turning on or off the lights on the plurality of trees.

According to this embodiment, an indicator light is also newly added to determine a product working status in real time, thereby facilitating user operation.

In terms of structure, the device in this embodiment is powered in a point contact mode, which can effectively avoid the wire winding problem during assembly and increase the stability of the device. A controller button cap is directly injection-molded on a housing of the base, which saves cost.

Furthermore, the design solution is further optimized by directly welding a contact piece of the battery box on the controller, and the conventional step of connecting via a wire is omitted, thereby saving cost. Meanwhile, a fixed pillar of a control board is also optimized by adding a protrusion design. After a circuit board is placed, it slightly sinks, such that a threaded pillar is directly clamped in a positioning hole in the circuit board, and the subsequent fixation and mounting of screws is facilitated.

A bushing with external threads is disposed at the tree-shaped bottom of the LED tree, and can be interconnected with threads in the base, thereby achieving higher reliability in fixation and better convenience in disassembly. In addition, a base plate of the LED tree is fixed in a snap-fit form, which simplifies product assembly.

That is, according to the utility model, a charge/discharge device body is controlled by the defined device. The defined device includes an LED tree body 1, in which a control mechanism for turning on or off the lights is disposed, and the on or off of the LED tree lights within a defined range is controlled in real time according to a wireless encoded signal by means of the control mechanism. The gang control of a plurality of LED tree lights can be implemented; and the sending and receiving of wireless data is more user-friendly and intelligent by means of 433M (315M or 2.4G) two-way wireless communication, that is, the wireless signal receiver J1 and the wireless signal emitter J2 may be 433M (315M or 2.4G). A point-contact power supply solution is used to avoid a wire winding problem during assembly. In addition, a contact pin has an elastic design, such that effective contact can be ensured when the contact pin leans against a contact piece, making the mode of power supply more stable and reliable. Meanwhile, the elastic design can also prevent a component from being damaged due to the deformation of a contact point during the leaning; the contact piece has an annular design, which can effectively ensure the contact between the contact piece and a landing point of the contact pin; furthermore, both ends of the contact piece are each provided with an insert tab to facilitate the insertion into the base, making the assembly simpler and more convenient.

The embodiments above only provide specific and detailed descriptions of several implementations of the utility model, and therefore should not be construed as limiting the patent scope of the utility model. It should be noted that several variations and improvements can be made by those of ordinary skills in the art without departing from the concept of the utility model, and shall be construed as falling within the protection scope of the utility model. Therefore, the patent protection scope of the utility model shall be subjected to the accompanying claims.

What is claimed is:

1. A switch gang-control device based on LED tree lights, comprising:
an LED tree body;
a control mechanism disposed in the LED tree body for turning on or off the lights, wherein the on or off of the LED tree lights within a defined range is controlled in real time according to a wireless encoded signal by means of the control mechanism;
a control circuit for turning the on or off the LED tree light is disposed in the control mechanism;
a first processing chip is disposed in the control circuit, the first processing chip having a first pin, a second pin, a third pin, a fourth pin, a fifth pin, a sixth pin, a seventh pin and an eighth pin, wherein:
the first pin of the first processing chip is connected to a power end and one end of a third capacitor: the other end of the third capacitor and the eighth pin of the first processing chip are grounded jointly;
the second pin of the first processing chip is electrically connected to a wireless signal receiver;
the third pin of the first processing chip is connected to one end of a first switch, and the other end of the first switch is grounded;
the fifth pin of the first processing chip is electrically connected to a wireless signal emitter; and the seventh pin of the first processing chip is connected to one end of a first resistor, the other end of the first resistor is connected to a base electrode of a first triode, an emitter electrode of the first triode is grounded, a collector electrode of the first triode is connected to one end of a second resistor, the other end of the second resistor is connected to a negative electrode of a first LED light, and a positive electrode of the first LED light is connected to a power input end; and
the sixth pin of the first processing chip is connected to one end of a third resistor, the other end of the third resistor is connected to a negative electrode of a second LED light, and a positive electrode of the second LED light is connected to the power input end.

2. (canceled)

3. (canceled)

4. (canceled)

5. The switch gang-control device based on the LED tree lights according to claim 1, wherein
the first processing chip is configured to encode data and send the encoded data to an LED tree within the defined range by means of a wireless signal sending circuit; and
to process a wireless signal received by a wireless signal receiving circuit and control the on or off of the LED tree lights according to data obtained by processing.

6. (canceled)

7. The switch gang-control device based on the LED tree lights according to claim 1, wherein
the LED tree body is specifically powered in a point contact mode; and
the point contact mode is defined as a state where a contact pin leans against a contact piece.

8. The switch gang-control device based on the LED tree lights according to claim 7, wherein:
a contact pin disposed in the point contact mode is specifically an elastic contact pin; a contact piece disposed in the point contact mode is specifically an annular contact piece; and
both ends of the contact piece are each provided with an insert tab for insertion into a base.

9. The switch gang-control device based on the LED tree lights according to claim 1, wherein:
an indicator light for determining a product working status is disposed on the LED tree body; and
a controller button cap is disposed in the control mechanism; and the button cap is injection-molded on a housing of the base of the LED tree body.

10. A method for applying a switch gang-control device based on LED tree lights, the switch gang-control device comprising a control mechanism for turning on or off the lights is disposed in a LED tree body,
the on or off of the LED tree lights within a defined range is controlled in real time according to a wireless encoded signal by means of the control mechanism,
a control circuit for turning the on or off the LED tree lights is disposed in the control mechanism;
a first processing chip is disposed in the control circuit, the first processing chip having a first pin, a second pin, a third pin, a fourth pin, a fifth pin, a sixth pin, a seventh pin and an eighth pin, wherein:
the first pin of the first processing chip is connected to a power end and one end of a third capacitor; the other end of the third capacitor and the eighth pin of the first processing chip are grounded jointly;
the second pin of the first processing chip is electrically connected to a wireless signal receiver;
the third pin of the first processing chip is connected to one end of a first switch, and the other end of the first switch is grounded;
the fifth pin of the first processing chip is electrically connected to a wireless signal emitter; and the seventh pin of the first processing chip is connected to one end of a first resistor, the other end of the first resistor is connected to a base electrode of a first triode, an emitter electrode of the first triode is grounded, a collector electrode of the first triode is connected to one end of a second resistor, the other end of the second resistor is connected to a negative electrode of a first LED light, and a positive electrode of the first LED light is connected to a power input end; and
the sixth pin of the first processing chip is connected to one end of a third resistor, the other end of the third resistor is connected to a negative electrode of a second LED light, and a positive electrode of the second LED light is connected to the power input end,
the method comprising the following steps:
emitting, based on the on or off of a switch mechanism disposed in any one of LED tree bodies, a wireless encoded signal corresponding to the LED tree body by a wireless signal emitter;
receiving the wireless encoded signal in real time by means of a wireless signal receiver disposed in an LED tree within a defined range; and
controlling the on or off of the LED tree lights within the defined range in real time in combination with the switch mechanism of the LED tree body according to the received wireless encoded signal.
